(19) United States
(12) Patent Application Publication
(10) Pub. No.: US 2009/0171884 A1
(43) Pub. Date: Jul. 2, 2009

(54) SYSTEM AND METHOD FOR WEB-BASED CASE MANAGEMENT

(76) Inventor: Steven C. Wright, Coronado, CA (US)

Correspondence Address: NYDEGGER & ASSOCIATES, 348 OLIVE STREET, SAN DIEGO, CA, 92103, US

(21) Appl. No.: 11/966,420

(22) Filed: Dec. 28, 2007

(51) Int. Cl. G06F 17/30

(52) U.S. Cl. 707/1; 707/E17.005

(57) ABSTRACT

A web-based case management system includes a centrally-located database for electronically storing case information including data, documents, and images. Further, the system includes an interface webpage that is viewable at a remote location. On the interface webpage, a plurality of links is provided, and each link is associated with specific case information. Also, the system provides a plurality of content webpages accessed by a user via respective links. When accessed, a content webpage displays the case information stored in the database and associated with the selected link. In addition to providing access to case information, the system also processes case information and generates reports. Specifically, the reports include selected case information and have a consistent format and appearance.

### FIELD OF THE INVENTION

The present invention pertains generally to a system and to a method for inputting and organizing information through an internet or web-based portal. More particularly, the present invention pertains to systems and methods that are employed to store information in diverse forms and from diverse sources at a central database. The present invention is particularly, but not exclusively, useful as a system and a method that uses a central electronic database to prepare on-line exhibits and hard copy reports of selected information at remote locations.

### BACKGROUND OF THE INVENTION

A legal case concerning construction defects and related matters can involve massive amounts of information. As a result, a single case may require hundreds of boxes to store physical records of the case information. In view of the volume of case information, significant labor costs are often necessary simply to manage the documents and compile needed information. Moreover, locating specific information from physical documents can be time consuming and inefficient. Also, physical records require considerable amounts of storage space.

Adding to the difficulty of managing physical records in a legal case is the fact that the case information is typically collected in a variety of forms. For instance, the case information may include legal pleadings and motions submitted by the opposing side, hand written field reports from investigators, maps, images of alleged defects, spreadsheets, electronic records, and various other documents. Also, a number of parties may need access to the case information during the course of the case. For instance, attorneys, insurance companies, forensic consultants, expert witnesses and other parties may need specific case information or reports prepared from case information. Of course, these parties are typically geographically dispersed. As a result, there may be significant delays between the time a party ascertains the need for specific case information and the time the party receives the information.

In light of the above, it is an object of the present invention to provide a system and method for electronically managing case information. Another object of the present invention is to provide a system and method for storing case information at a central location and exhibiting the case information and related reports at remote locations. Another object of the present invention is to provide a system and method for generating reports including selected case information in a consistent format and appearance. Yet another object of the present invention is to provide a web-based case information management system that is easy to implement, is simple to use and is comparatively cost effective.

### SUMMARY OF THE INVENTION

The present invention provides a system and method for the purpose of managing case information and providing real-time access to the case information. In the system, an electronic database is used to store case information including data, documents, and images at a central location. Further, the system includes an interface webpage viewable at a remote location. For purposes of the present invention, the interface webpage includes a plurality of links that are each associated with specific case information. Also, the interface webpage includes a security device for restricting access to the case information. Specifically, the interface webpage may require a log in name and pass code before access to the links is granted. After access is granted, one or more links may be selected on the interface webpage.

For purposes of the present invention, the system generates a plurality of content webpages that are viewable at locations remote from the central location of the database. Specifically, each content webpage may be accessed by a user via a selected link or a plurality of selected links. Further, each content webpage displays the specific case information stored in the database and associated with the selected link or links.

In order to process the case information, the system includes a server that is connected to the electronic database and supports the interface webpage. Through selection of a link or links on the interface webpage, the server generates the appropriate content webpage. Also, for appropriate personnel, the server allows case information to be input into the electronic database through the interface webpage or through a content webpage. In addition, the server can be used to generate standardized reports including certain selected case information. Typically, the format for each standardized report, and the case information needed for each report, is saved in the database and is accessed by the server. As a result, reports having a consistent format may be prepared immediately for the user.

In order to implement use of the system, case information is inputted into the electronic database through a webpage. For purposes of the present invention, a user may input or edit case information only upon entering a log in name and pass code assigned to an administrator security level. After case information is entered into the electronic database, it is immediately available for viewing by other users. Specifically, after entering a log in name and pass code at the interface webpage, a second user may select a link associated with certain case information. In response, the server locates the case information associated with the link and displays it in a format saved in the database. Further, the links on the interface webpage may also be used to solicit a standardized report. For example, a user may select a link associated with a job number and a defect inspection list. As a result, the server will locate and prepare a report including the section number, section name, description number, and description name for the desired job number.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic drawing showing the components of the case management system in accordance with the present invention; and

FIG. 2 is an exemplary embodiment of an interface webpage for the system shown in FIG. 1.

### DESCRIPTION OF THE PREFERRED EMBODIMENTS

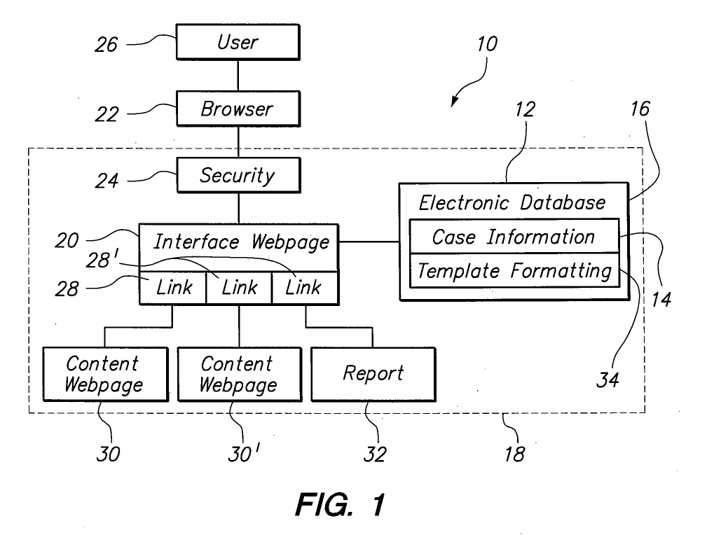

Referring initially to FIG. 1, a web-based case management system is shown, and is generally designated 10. As shown, the system 10 includes a database 12 for electronically storing case information 14 at a central location 16. Also, the system 10 includes a server 18 that is electronically connected to the database 12. In the system 10, the server 18 is further connected to and supports an interface webpage 20 that may be accessed by a browser 22 at a remote location. As shown, the system 10 includes a security mechanism 24 that permits access to the interface webpage 20 by a user 26. For instance, the security mechanism 24 may require that the user 26 enter a log in name and a pass code before access to the interface webpage 20 is granted. Preferably, the security mechanism 24 includes varying levels of access to the interface webpage 20. For example, a log in name may be assigned to an Administration, Management or Employee security level. At these security levels, the user 26 may enter and edit case information 14 in the database 12. Alternatively, the log in name may be assigned to an Attorney/Carrier or Attorney/Firm security level which limits the user to viewing certain limited case information 14, as determined by an Administration level user 26.

Still referring to FIG. 1, it can be seen that the interface webpage 20 includes a plurality of links 28. The links 28 may be in the form of drop-down menus, hyperlinks, or other selectable web mechanisms. For the present invention, each link 28 is associated with a respective category of case information 14 and accesses a content webpage 30. For instance, one link 28′ lists a specific housing development. Selection of the link 28′ may be performed by entering the name of the specific housing development in an entry box on the interface webpage 20, by selecting a button directly associated with the specific housing development, or by similar known methods. As a result of selecting the link 28′, the server 18 creates the content webpage 30′ for display on the browser 22. Further the content webpage 30′ will identify all buildings including a designation as belonging in the specific development. This operation is performed by the server 18 automatically and immediately upon selection of a link 28 through an examination of the case information 14 stored by the database 12. With this operation understood, it can be foreseen that the selection of a plurality of links 28 will result in the creation of a content webpage 30 highly specialized to the user's needs.

In addition to creating the content webpages 30, the server 18 is similarly able to generate reports 32. Specifically, some links 28 will be programmed to locate predetermined groups of case information 14 for use in reports 32 having consistent formats and appearances. Specifically, a report 32 will include the report-specific case information 14 in a standardized structure provided by the database 12. In FIG. 1, the database 12 includes a formatting template 34 tailored to each type of desired report 32. Due to the generation of consistent reports 32, the pertinent case information 14 contained in the reports 32 is easily located for use by the parties involved in the case.

For the system 10, the reports 32 may include: an Address List containing information pertaining to the lot, address, street, phase, plan type, tract, unit, building, building type, sub division, resident, notice of completion (NOC), in suit and by client; an Inspection List containing lot, address, street, unit, building, phase, plan type, inspector, date of inspection, type of inspection, in suit and by client; a Project Information Sheet containing the client's contractor license, project name, project description, approving authority, municipality, building codes, occupancy type, construction type, construction date, the forensic consultant scope of assignment and client's scope of work; a Case Data Sheet containing job number, status, case name, company, client name, trade, opened date, job type, project manager, number of units, project location, project information, attorney, firm, address, phone, fax, carrier, adjuster, address, phone, fax, and expert information; a List of All Documents containing descriptions of documents and dates received; a List of Documents Reviewed containing descriptions of documents and dates of documents reviewed; a List of Depositions Reviewed containing deponents, who they represent and date of deposition; a List of Experts containing who they represent, name of expert, firm, and activity; a Case Budget and a Case Budget (Revised) which contain projected costs by phase for a forensic consultant and co-expert; a Budget Letter and Budget Letter (Revised) which contain letters to attorneys or adjusters based on who the primary contact is; an Estimated Budget containing budget worksheet with projected costs and costs spent for the forensic consultant and co-expert; an Expert Retention Letter with budget worksheet; a Retention Letter to attorney or adjuster based on who is primary contact; a Response Document containing the Plaintiff's, Developer's, and forensic consultant's response for each issue, Plaintiff's, Developer's, and forensic consultant's standards and references for each issue, Plaintiff's, Developer's, and forensic consultant's repair recommendations for each issue, Plaintiff's and Developer's costs for each issue and forensic consultant's costs for each issue based on forensic consultant's cost of repair scenario; a Defect Inspection List containing section number, section name, description number, and description name; a Defect Listing containing section number, section name, description number, description name; an Allocation by Issue containing defect, trade, subcontractor, percentage, comments, scope of work for Plaintiff, Developer and forensic consultant costs; an Allocation by Trade containing defect, trade, subcontractor, percentage, comments, scope of work for Plaintiff, Developer and forensic consultant costs; Trade Allocation Totals containing trade, subcontractor, total cost of defects allocated, and total percentage of responsibility; a Conflict Check containing search function by plaintiff, developer, client and project; a Forensic Consultant Cost of Repair (COR) containing scenarios, COR summary, COR details, COR repair details, comparative summary and comparative details; and Images containing printing photos in binder style (four to a page) with date of image, inspector, type of inspection, image number, and deposition style (one to a page) with date of image, inspector, image number, address, caption, description number and name.

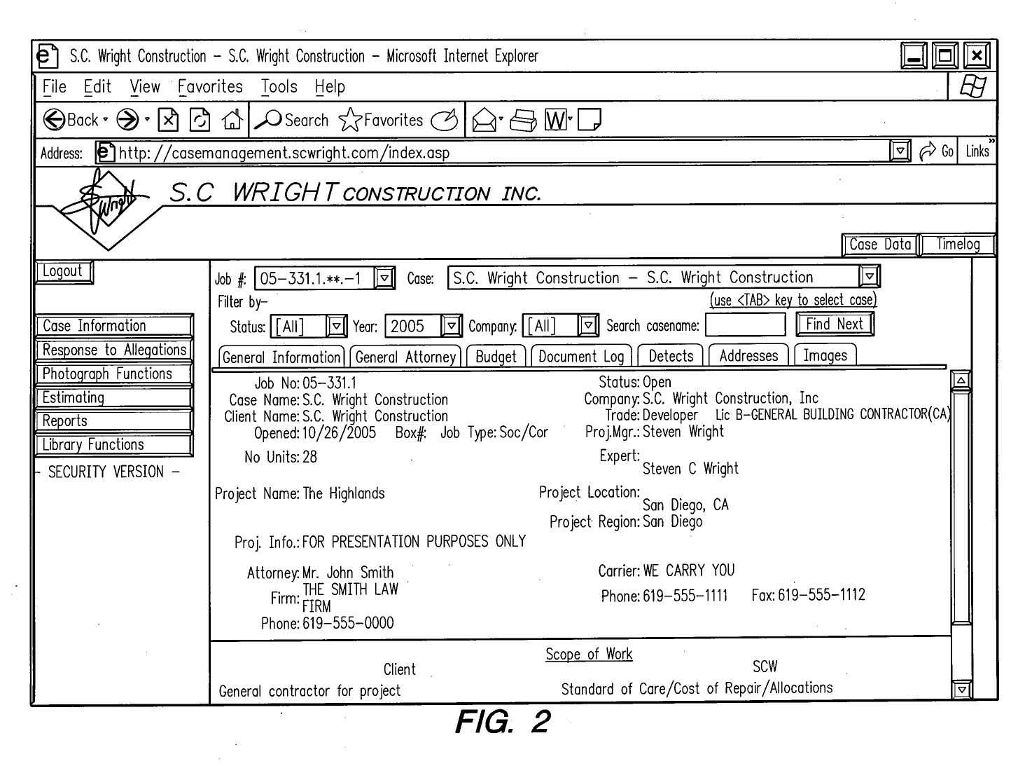

Referring now to FIG. 2, a sample interface webpage 20 is shown to incorporate tabs organizing the case information 14 into General Information, Carrier/Attorney, Budget, Document Log, Defects, Addresses and Images. For the system 10, the case information 14 may include the following general case information: the job number, the status of the case, the case name, the company name, the client name, the trade involved, the type of license involved, the date the case was opened, the storage box number for when the case is closed, the job type, the project manager, the number of units involved, the project location, the project region, project information, the attorney, the attorney's firm, the attorney's contact information, the carrier, the carrier's contact information, the scope of work involved, the schedule, the name of the depository and the related contact information, the events and related due dates, status, identification of requesting party, identification of party assigned to event, the associated department, and the task involved.

Also, the Attorney/Carrier tab includes the attorney, the attorney's firm, the attorney's contact information, the attorney's file number, the attorney's paralegal, the attorney's secretary and contact information, the primary contact for the attorney, the attorney's contact for bills, the carrier, the carrier's contact information, the carrier rate, the adjuster and contact information, the carrier claim number, the carrier file number, the primary contact for the carrier, the carrier's contact for bills, and the discount type.

Further, the budget information may include: the budget revision date, the total projected budget, the projected budget for site inspection, the projected budget for DT inspection, the projected budget for gen invest, the projected budget for preliminary reports, the projected budget for med. & misc. prep, the projected budget for final reports, the projected budget for deposition, the projected budget for trial, the total incurred costs, the incurred cost for site inspection, the incurred cost for DT inspection, the incurred cost for gen invest, the incurred cost for preliminary reports, the incurred cost for med. & misc. prep, the incurred cost for final reports, the incurred cost for deposition, the incurred cost for trial, the co-expert total projected budget, the co-expert projected budget for site inspection, the co-expert projected budget for DT inspection, the co-expert projected budget for gen invest, the co-expert projected budget for preliminary reports, the co-expert projected budget for med. & misc. prep, the co-expert projected budget for final reports, the co-expert projected budget for deposition, the co-expert projected budget for trial, the total co-expert incurred costs, the co-expert incurred cost for site inspection, the co-expert incurred cost for DT inspection, the co-expert incurred cost for gen invest, the co-expert incurred cost for preliminary reports, the co-expert incurred cost for med. & misc. prep, the co-expert incurred cost for final reports, the co-expert incurred cost for deposition, and the co-expert incurred cost for trial.

Also, the document log may include the following data: who logged or sent the document, the status of the document, the date the document was received, the date the document was sent, the date of the document, who the document was received from, who the document was sent to, how the document was received, how the document was sent, a description of the document, i.e., legal documents, images and field notes, plans, site maps, plaintiff's reports, plaintiff's cost of repair, developer's reports, developer's cost of repair, client's job file documents such as subcontracts, change orders, homeowner's list, a deposition list including the date of deposition, the deponent, and the party the deponent represents.

Additionally, the defect information may include a section number, a section name, a description number, a description name, the date inputted, the plaintiff's costs, the plaintiff's burden percentage, the forensic consultant's burden percentage, the developer's costs, the developer's burden percentage, and the assignment of defects to images.

Further, the case information 14 may comprise address information for the buildings related to the case, including the lot numbers of the buildings, the buildings' addresses, street names, units, buildings, plan types, phases, building types, sub-divisions, tracts, residents, notices of completion, an indication of whether the building is in the law suit, and an indication of whether the building is within the client's scope of work.

Also, the case information 14 may include the following image information: an image, the location of the image, a caption for the image, field notes relating to the image, whether the image is archived only, what defects are observed in the image, addresses assigned to the image, and information relating to the addition of the image to the database including the image date, the inspector's initials, the type of inspection, and the drive from which the image was loaded.

Referring back to FIG. 1, the system 10 may include a link 28 for each type of case information 14 listed above. Further, multiple links 28 may be simultaneously selected by a user 26. As a result, the server 18 will generate a content webpage 30 including the case information 14 associated with the selected links 28.

As shown in FIG. 2, in addition to the organization of case information 14 listed above, the system 10 provides several menus which further organize case information 14. As shown, the menus are entitled Case Information, Response to Allegations, Photograph Functions, Estimating, Reports and Library Functions. The Case Information Menu comprises an Add Master Case including a job modifier, case name, date opened, forensic consultant company, location, and client name. Further, the Case Information Menus includes an Add Subcase with a client name and date opened. Also, the Case Information Menu comprises binder covers containing the volume data, section cover sheet labels, print end labels, and print binder front. Further, in the Case Information Menu, there is a search function in which the case information may be searched by case name, client name, open date, modifier type, project manager, and legacy case number.

In the Response to Allegations menu, the project information/master case information contain description, zoning, occupancy type, construction type, construction date, approving authority, municipality, building codes, i.e. UBC, NEC, NPC, UMC, etc. information. Further, under the Response to Allegation menu, response document information includes the Plaintiff's, Developer's, and forensic consultant's response for each issue, the Plaintiff's, Developer's, and forensic consultant's standards and references for each issue, and the Plaintiff's, Developer's, and forensic consultant's repair recommendations for each issue. Also, the Response to Allegations tab leads to site inspection information such as the date of inspection, inspector, lot, address, street, unit, phase, and type of inspection. Further, the Response to Allegations tab links to a list of experts including the name of expert, firm, party represented, activity, and type of expert.

In the Estimating menu, the interface webpage 20 allow an administrative user 26 to enter into the database 12 a cost of repair; to create a new scenario; to edit an existing scenario; to copy an existing scenario to a new scenario; to rename an existing scenario; to enter repair locations; to enter notes; to enter cover sections and repair line items containing a recommendation library, activity/repair line item, notes, comments, repair step number, print notes, rates library, number of locations, unit quantity, rates not included in rates library; and to enter allocations of plaintiff's cost of repair containing defect, trade, subcontractor, percentage, comments, and scope of work information.

Under the Library Functions menu, the administrative user 26 may manage experts including the name of the expert, phone, fax, discipline, firm, address, if full time employee, if contracted. Further, under the Library Functions menu, the administrative user 26 may manage lists including the Allocation Trades Listing (containing a list of subcontractor trades and if active), Case Prefix, Contractor Licenses Listing (containing license class number and license class name by state), Defect Type Listing, Document Status Listing, Document Types Listing, Event Status Listing, Expert Discipline Listing, Expert Representing Listing, Inspection Type Listing, Job Status Listing, Job Type Listing, Name Prefixes Listing, Project Phases Listing, Forensic Consultant Companies Listing (containing company initials, company name, company address, state disclaimer), Trades Listing, and Unit Type Listing. Also, under the Library Functions menu, the administrative user 26 may manage user information including user name, position, if project manager (PM), if active, extension, fax, email, home phone, cell, user name and password, setting security level, setting if associated with a carrier or law firm, viewing and modifying time log tasks. Moreover, under the Library Function menu the administrative user 26 may manage security groups, manage estimating rates (containing category, name of trade, price, type of unit, comments and if active information), manage Estimating Recommendations (containing category, name of activity, recommendation, price, type of unit, number of units, comments and if active information, manage Regions, manage Region Rate Factors (containing base rates and rate factor percentages), and manage the Case/Trade/Companies Listing (containing trade, subcontractor, comments and scope of work for allocations).

For the present invention, the interface webpage 20 may further include an Administration Button in which a Time Log Report containing information relating to employees' time on a day, month, year or specific amount of time summary and detail report. Also, a Timelog Button may be included on the interface webpage 20 which includes job number, date, billing phase, billable time, travel time, and task for billing purposes.

### Operation

In operation of the system 10, an administrative user 26 utilizes a browser 22 to access the interface webpage 20. Upon verification of the user's security level by the security mechanism 24, the user 26 may enter case information 14 into the electronic database 12 through the interface webpage 20 or through a content webpage 30. Thereafter, the case information 14 is stored in the electronic database 12 at the central location 16.

As soon as the case information 14 is entered into the electronic database 12, it may be viewed by other authorized users 26. For instance, an attorney user 26 may access the interface webpage 20 through a browser 22 at a remote location. After clearing the security mechanism 24, the attorney user 26 may search for specific case information 14, such as the number of specified defects in a case, by choosing the appropriate links 28. If the attorney user 26 has access to that case information 14, the server 18 will immediately generate and display a content webpage 30 including the selected case information 14. Likewise, a user 26 may request a specific report by selecting the appropriate link 28. Again, if the user 26 has clearance, the server 18 will immediately prepare the report 32 in the standardized template formatting 34.

While the particular System and Method for Web-based Case Management as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A web-based case management system comprising:
a database for electronically storing case information including data, documents, and images at a central location;
an interface webpage viewable at a remote location and including a plurality of links, with each link being associated with specific case information;
a plurality of content webpages viewable at the remote location, wherein each content webpage is accessed by a user via a selected link, and wherein each content webpage displays the specific case information stored in the database and associated with the selected link; and
a server connected to the database and the interface webpage for processing the case information and for generating the content webpages and reports including selected case information and having a consistent format and appearance.

2. A case management system as recited in claim 1 further comprising a security means for restricting access to the content webpages.

3. A case management system as recited in claim 2 wherein the security means requires the user to input a log in name and a pass code.

4. A case management system as recited in claim 3 wherein each log in name is assigned to a security level selected from a group consisting of Administration, Management, Employee, Attorney/Carrier, and Attorney/Firm.

5. A case management system as recited in claim 4 wherein inputting a log in name assigned to the Administration, Management or Employee security level allows the user to enter case information to the database through a selected webpage.

6. A case management system as recited in claim 4 wherein inputting a log in name assigned to the Attorney/Carrier or Attorney/Firm security level limits the user to viewing case information.

7. A case management system as recited in claim 1 wherein the plurality of links on the interface webpage are organized under tabs including general information, attorney/carrier, budget, document log, defects, addresses, and images.

8. A case management system as recited in claim 7 wherein the server generates content webpages displaying case information associated with a plurality of selected links.

9. A web-based case management system comprising:
a means for electronically storing case information including data, documents, and images at a central location;
a means for restricting access to the case information to a desired user;
a means for exhibiting a catalog of the case information for selection by the desired user at a remote location;
a means for displaying the case information selected by the desired user at the remote location;
a means for searching the case information using a plurality of inputs; and
a means for generating reports including selected case information and having a consistent format and appearance.

10. A case management system as recited in claim 9 wherein the storing means is an electronic database.

11. A case management system as recited in claim 10 wherein the exhibiting means is an interface webpage including a plurality of links, with each link being associated with specific case information exhibited in the catalog.

12. A case management system as recited in claim 11 wherein the displaying means is a content webpage that is accessed via a respective link on the interface webpage.

13. A case management system as recited in claim 12 wherein the searching means and generating means include a server connected to the database, interface webpage and content webpage.

14. A case management system as recited in claim 13 wherein the restricting means requires the desired user to input a log in name and a pass code.

15. A case management system as recited in claim 14 wherein each log in name is assigned to a security level selected from a group consisting of Administration, Management, Employee, Attorney/Carrier, and Attorney/Firm.

16. A case management system as recited in claim 15 wherein inputting a log in name assigned to the Administration, Management or Employee security level allows the desired user to enter case information to the database through a selected webpage.

17. A case management system as recited in claim 15 wherein inputting a log in name given the Attorney/Carrier or Attorney/Firm security level limits the desired user to viewing the case information.

18. A method of providing a web-based case management system comprising the steps of:
electronically storing case information including data, documents, and images in a database at a central location;
providing an interface webpage viewable at a remote location and including a plurality of links, with each link being associated with specific case information;
creating a plurality of content webpages, wherein each content webpage is accessed by a user via a respective link, and wherein each content webpage displays the specific case information stored in the database and associated with the selected link; and
connecting a server to the database, interface webpage and content webpages for processing the case information.

19. A method as recited in claim 18 further comprising the step of automatically generating reports including selected case information and having a consistent format and appearance.

20. A method as recited in claim 19 further comprising the step of restricting access to content webpages to desired users.
